(19) United States
(12) Patent Application Publication
(10) Pub. No.: US 2023/0073539 A1
(43) Pub. Date: Mar. 9, 2023

(54) PLOUGH ASSEMBLY

(71) Applicant: AUSPLOW PTY. LTD., Cockburn Central WA (AU)

(72) Inventor: John William RYAN, Cockburn Central WA (AU)

(73) Assignee: AUSPLOW PTY. LTD., Cockburn Central WA (AU)

(21) Appl. No.: 17/892,391

(22) Filed: Aug. 22, 2022

(30) Foreign Application Priority Data
Aug. 24, 2021 (AU) 2021221492

(51) Int. Cl. A01B 63/32; A01B 61/04; F16K 17/10

(52) U.S. Cl. CPC A01B 63/32; A01B 61/04; F16K 17/10

(57) ABSTRACT

A plough assembly (100) to be mounted on a beam (10) to be moved in a longitudinal forward direction (12) over a soil layer, having a soil surface, to be worked by the assembly (100), the assembly (100) including:
a digging shank (110) to extend downwardly into the soil layer;
a digging point (120) having a lowermost extremity (122) and to be fixed to a lower portion (112) of the shank (110);
a pivotable connector (130) to connect the digging shank (110) to the beam (10);
a fluid cylinder (140) mounted across the pivotable connector (130) such that pivoting of the shank (110) causes movement of the cylinder (140), the cylinder (140) being connected to a plough fluid line (150);
a pressure reducing valve (160) connecting the plough fluid line (150) to a fluid circuit (170), the pressure reducing valve (160) being adapted to release fluid pressure from the plough fluid line (150) to the fluid circuit (170) at a pre-determined over-pressure point.

### FIELD

This invention relates to a tine assembly.

### BACKGROUND

Described in Australian Patent No. 2007202351, which is incorporated herein in its entirety by reference thereto, is a plough assembly to be fixed to a plough frame that includes a transverse beam. The plough assembly includes a plough shank with a leading surface that is s generally upwardly oriented. The lower end of the shank is provided with a digging adapter to which there is attached a digging blade. Located behind the adapter is a fertiliser delivery tube, while behind the tube is a seed delivery tube. A seed bed is formed by a tool that is in front of the tube, while behind the tube is a press wheel. Australian Patent No. 2014218389, which is incorporated herein in its entirety by reference thereto, also relates to a plough assembly with a tool that is attached to a plough frame with an adaptor so as to provide for height adjustment of the tool.

Previously known plough assemblies have suffered from a number of disadvantages. Firstly, plough assemblies typically disturb root systems below the seed planting level, which can lead to overly compacted soil. Similarly, the press wheel used on a number of plough assemblies can compact soil to an undesirable degree. Yet further, when the leading surface of the plough shank encounters obstacles in the soil to be ploughed, the shank can either be damaged or lifted permanently from its desired seed planting position.

### SUMMARY

It is an object of the present invention to at least substantially address one or more of the above disadvantages, or at least provide a useful alternative to the above plough assemblies.

In a first aspect the present invention provides a plough assembly to be mounted on a beam to be moved in a longitudinal forward direction over a soil layer, having a soil surface, to be worked by the assembly, the assembly including:

a digging shank to extend downwardly into the soil layer;

a digging point having a lowermost extremity and to be fixed to a lower portion of the shank;

a pivotable connector to connect the digging shank to the beam;

a fluid cylinder mounted across the pivotable connector such that pivoting of the shank causes movement of the cylinder, the cylinder being connected to a plough fluid line;

a pressure reducing valve connecting the plough fluid line to a fluid circuit, the pressure reducing valve being adapted to release fluid pressure from the plough fluid line to the fluid circuit at a pre-determined over-pressure point.

Preferably, the plough assembly further includes an accumulator connected to the plough fluid line.

Preferably, the fluid circuit includes a pressure relief valve having a pilot port and a first and a second directional ports, the pilot being connected to the plough fluid line and the directional ports being connected in series to the fluid circuit.

Preferably, the pressure relief valve includes a spring member acting against the pilot port to provide an unload/reload pressure ratio.

Preferably, the fluid circuit includes a vented directional valve having a vent port and a first and a second directional ports, the vent port being connected to the first directional port of the pressure relief valve, the first directional port being connected to the plough fluid line, and the second directional port being connected to the fluid circuit, such that when the vent port experiences a rapid pressure drop the fluid circuit is connected to the plough fluid line.

Preferably, the plough assembly further includes a check valve between the first directional port of the vented directional valve and the plough fluid line such that fluid flow is not possible from the plough fluid line to the vented directional valve.

Preferably, the check valve is biased closed such that fluid flow from the vented directional valve to the plough fluid line is only possible when the fluid pressure at the first directional port of the vented directional valve is higher than the fluid pressure in the plough fluid line by a pre-determined value.

Preferably, the fluid circuit includes a line restriction between the fluid circuit and the second directional port of the pressure relief valve.

Preferably, the plough assembly includes a plurality of digging shanks to extend downwardly into the soil layer;

a plurality of digging points having a lowermost extremity and to be fixed to a lower portion of the respective shanks;

a plurality of pivotable connectors to connect the respective digging shanks to the beam;

a plurality of fluid cylinders mounted across the respective pivotable connectors such that pivoting of the shank causes movement of the respective cylinder, each cylinder being connected to the plough fluid line.

Preferably, the pressure applied to the digging point by the soil causes pivoting of the respective shank in a first direction, resulting in compression of the respective cylinder resulting in an increase of fluid pressure in the plough fluid line such that the remainder of the plurality of fluid cylinders expands creating a moment to the remainder of the plurality of digging points in a second direction opposite the first direction.

Preferably, the digging point includes a chisel tool, the chisel tool having a digging angle of about 6 degrees relative to the longitudinal forward direction.

Preferably, the chisel tool includes a chisel tool point, the chisel tool point having a digging angle of about 30 degrees relative to the longitudinal forward direction.

Preferably, the chisel tool point includes a wear member adapted to resist abrasion by the soil.

Preferably, the chisel tool is adapted to work at a depth between 200 mm to 230 mm.

Preferably, the plough assembly further includes a seed bed forming tool supported so as to be behind the digging point and to work at a depth of 30 mm to 70 mm to form the seed bed at a location higher than the lowermost extremity,

wherein the seed bed forming tool is pivotally connected to an adaptor that is pivotally connected to the digging shank, such that vertical motion of the seed bed forming tool as a result of vertical motion of the digging shank is inhibited.

Preferably, the plough assembly further includes a seed delivery tube attached to the seed bed forming tool to deliver a seed to the bed formed by the seed bed forming tool.

In a second aspect, the present invention provides a plough assembly to be mounted on a beam to be moved in a longitudinal forward direction over a soil layer, having a soil surface, to be worked by the assembly, the assembly including:

a digging shank to extend downwardly into the soil layer;

a digging point having a lowermost extremity and to be fixed to a lower portion of the shank;

a seed bed forming tool supported so as to be behind the digging point, the seed bed forming tool forming a seed bed at a location higher than the lowermost extremity;

a seed delivery tool to deliver a seed to the bed formed by the seed bed forming tool; and

a wheel member to engage the soil behind the seed delivery tool to aid in ensuring the seed delivered to the bed is covered by soil,

wherein the wheel member includes a plurality of radially extending blades, each blade adapted to, as the wheel member traverses the soil, move a portion of soil, thereby forming a furrow.

Preferably, the blades are angled backward such that an extremity of each blade, when the respective blade is in contact with the soil layer, is oriented at a smaller angle to the soil layer than a root portion of the respective blade.

Preferably, the blades are angled such that the extremity of the blade is substantially parallel to the soil layer when the extremity has contacted the soil layer and has moved behind a center of the wheel member.

Preferably, each blade has a root portion from which the blade extends radially outward, and

wherein the blade is angled forward relative to a wheel radius at the root portion.

Preferably, the blade is angled forward relative to the wheel radius at the root portion such that, when the extremity of the blade is directly below the center of the wheel member, the extremity of the blade is angled into the soil layer to scoop the portion of soil.

Preferably, the blades of the wheel member are made from a compliant material, such as polyurethane.

Preferably, each blade has a width of between 50 mm to 150 mm, more preferably between 90 mm to 135 mm.

Preferably, the radially extending blades are connected to each other by a support ring located a radial distance away from a center of the wheel member to inhibit azimuthal movement of the blades between the support ring and a center of the wheel member.

Preferably, the support ring has a D-shaped cross-section, the curved side extending radially outward.

Preferably, an extremity of each blade has a narrower width than the majority of the blade.

### BRIEF DESCRIPTION OF THE DRAWINGS

Preferred embodiments of the present invention will now be described by way of example, with reference to the accompanying drawings, wherein:

FIG. 1 is an isometric view of a plough assembly according to a preferred embodiment of the invention.

FIG. 2 is an isometric view of a digging shank of the plough assembly of FIG. 1.

FIG. 3 is a hydraulic circuit diagram of the plough assembly of FIG. 1.

FIG. 4 is an isometric view of a wheel member of the plough assembly of FIG. 1.

FIG. 5 is a left side view of the wheel member of FIG. 4.

FIG. 6 is a front elevation view of the wheel member of FIG. 4.

FIG. 7 is a detailed section view of the wheel member of FIG. 4.

FIG. 8 is an isometric view of a second embodiment of a wheel member of the plough assembly of FIG. 1.

### DETAILED DESCRIPTION

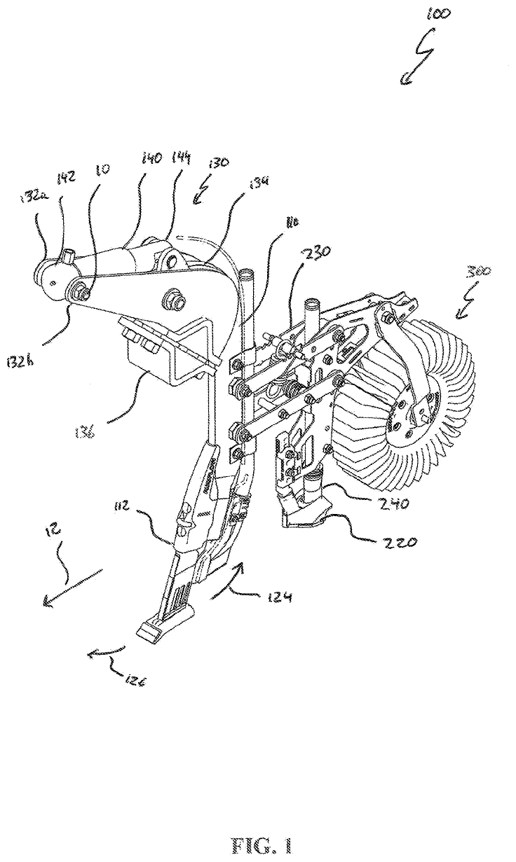

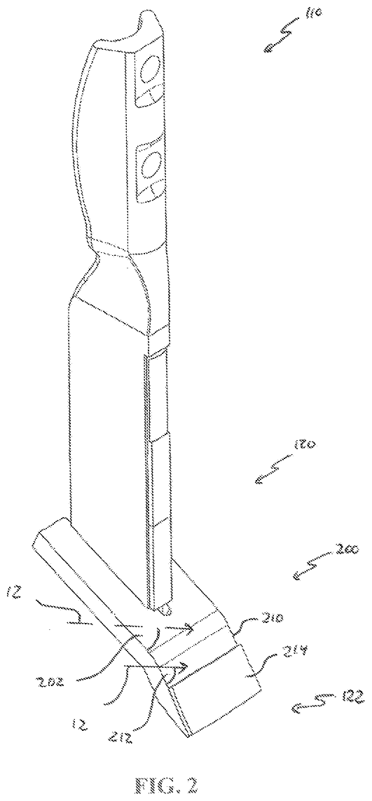

FIG. 1 shows a plough assembly 100 according to a preferred embodiment of the invention, to be mounted on a beam 10 and moved in a longitudinal forward direction 12 over a soil layer (not shown), having a soil surface (not shown). When moved over the soil layer, the plough assembly 100 works the soil surface. The plough assembly 100 includes a digging shank 110 to extend downwardly into the soil layer. The digging shank 110 is shown in more detail in FIG. 2 and has a digging point 120 having a lowermost extremity 122 that is fixed to a lower portion 112 of the digging shank 110.

Returning to FIG. 1, the plough assembly 100 includes a pivotable connector 130 to connect the digging shank 110 to the beam 10. The pivotable connector 130 includes a pair of outer plates 132a, 132b and an inner plate 134 pivotably mounted therebetween. The digging shank 110 is connected to the inner plate 134, while the outer plates 132a, 132b are connected to the beam 10. The pivotable connector 130 further includes a bracket 136 connecting the outer plates 132a, 132b adjacent to the pivotable connection to the inner plate 134. The plough assembly 100 further includes a fluid cylinder 140 mounted across the pivotable connector 130 by being connected, at a first end 142, to the beam 10 or outer plates 132a, 132b, and at a second end 144, to the inner plate 134. All references to fluid herein should be understood as referring to any type of fluid adapted to be used in a pressurized system, such as gases, liquids. In the preferred embodiment, hydraulic fluid is used. Thereby, pivoting of the digging shank 110 causes movement of the hydraulic cylinder 140. The hydraulic cylinder 140 is connected to a plough fluid line 150 such that a pressure of the hydraulic cylinder 140 is equal to a pressure in the plough fluid line 150 and vice versa.

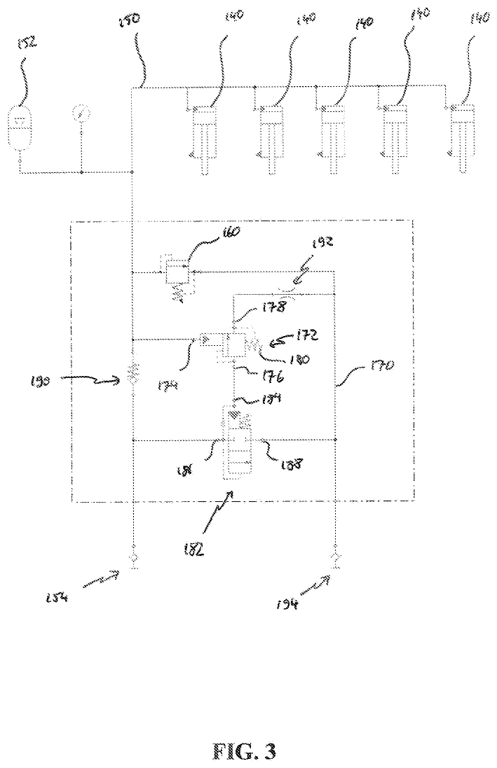

Moving now to FIG. 3, the plough assembly 100 further includes a pressure reducing valve 160 connecting the plough fluid line 150 to a fluid circuit 170. Preferably, the pressure reducing valve 160 is a RVD50-20 relief valve. The pressure reducing valve 160 is adapted to release fluid pressure from the plough fluid line 150 to the fluid circuit 170 at a pre-determined over-pressure point. Preferably, the over-pressure point is about 90 bar. The plough assembly 100 also includes an accumulator 152, preferably a nitrogen accumulator, connected to the plough fluid line 150.

Remaining with FIG. 3, the fluid circuit 170 includes a pressure relief valve 172 having a pilot port 174, a first directional port 176, and a second directional port 178. Preferably, the pressure relief valve 172 is a UP10-31 pressure unloading valve. In the rest position, the pressure relief valve prevents fluid flow between the directional ports 176, 178. When the pilot port 174 experiences sufficient pressure, fluid flow between the directional ports 176, 178 is permitted. If the second fluid port 178 experiences sufficient back pressure to overcome the pilot port 174 pressure, fluid flow between the directional ports 176, 178 is blocked. The pressure relief valve 172 also includes a spring member 180 to select the pilot port 174 pressure required to operate the valve 172, as well as provide an unload/reload pressure ratio. The pilot port 174 is connected to the plough fluid line 150, while the directional ports 176, 178 are connected in series to the fluid circuit 170.

The fluid circuit 170 further includes a vented directional valve 182 having a vent port 184, a first directional port 186, and a second directional port 188. Preferably, the vented directional valve is an EV10-S34 directional element. In the rest position, the valve 182 prevents fluid flow between the directional ports 186, 188. The valve 182 actuates when the vent port 184 experiences a sufficiently sharp pressure drop such that the valve 182 is urged into a position to allow fluid flow between the directional ports 186, 188. The valve 182 resets when the pressure at the vent port 184 has stabilized. The vent port 184 is connected to the first directional port 176 of the pressure relief valve 172. The first directional port 186 is connected to the plough fluid line 150, while the second directional port 188 is connected to the fluid circuit 170, such that the vented directional valve 182 is located between the first directional port 176 of the pressure relief valve 172 and the fluid circuit 172.

The fluid circuit 170 further includes a check valve 190 between the first directional port 186 of the vented directional valve 182 and the plough fluid line 150, such that fluid flow is not possible from the plough fluid line 150 to the vented directional valve 182. Preferably, the check valve 190 is a CV10-20 check valve. Preferably, the check valve 190 is biased closed such that fluid flow from the vented directional valve 182 to the plough fluid line 150 is only possible when the fluid pressure at the first directional port 186 of the vented directional valve 182 is higher than the fluid pressure in the plough fluid line by a pre-determined value.

Finally, the fluid circuit 170 includes a line restriction 192 between the fluid circuit 170 and the second directional port 178 of the pressure relief valve. The plough fluid line 150 includes a first quick disconnect 154 located between the check valve 190 and the vented directional valve 182, and the fluid circuit 170 includes a second quick disconnect 194.

In a preferred embodiment, the plough assembly 100 includes a plurality of digging shanks 110 to extend downwardly into the soil layer, and a plurality of digging points 112 having a lowermost extremity 122 and to be fixed to a lower portion 112 of the respective shanks 110. Similarly, a plurality of pivotable connectors 130 is included to connect the respective digging shanks 110 to the beam 10. Each pivotable connector 130 has a fluid cylinders mounted across the respective pivotable connector 130 such that pivoting of the respective shank 110 causes movement of the respective cylinder 130. Each fluid cylinder 130 is connected to a common plough fluid line 150.

Thereby, pressure applied to the digging point 120 by the soil causes pivoting of the respective shank 110 in a first direction 124, shown in FIG. 1, resulting in compression of the respective cylinder 140 and an increase of fluid pressure in the fluid cylinder 140. Thus, the pressure in the plough fluid line 150 also increases, as well as the pressure in each of the remaining fluid cylinders 140, such that the remainder of the plurality of fluid cylinders 140 expands. The expansion of the cylinders 140 causes a moment to the remainder of the plurality of digging points 120 in a second direction 126 that is opposite the first direction 124. As the remainder of the digging points 120 are urged forward and the digging angle of the shank 110 increases due to the motion, the remaining shanks 110 are urged in the direction 124, causing the digging point that was previously urged in the direction 124 to be urged in the direction 126 to reset to the original working position. Thus, the digging points 120 move in a pulsating motion. The pressure reducing valve 160 is not strictly required for this effect to be created, the interconnection of the fluid cylinders 140 using the plough fluid line 150 may be sufficient.

Returning to FIG. 2, the digging point 120 includes a chisel tool 200 that has a digging angle 202 of about 6 degrees relative to the longitudinal forward direction 12. The chisel tool 200 meanwhile includes a chisel tool point 210 that has a digging angle 212 of about 30 degrees relative to the longitudinal forward direction 12. The chisel tool point 210 includes a wear member 214 adapted to resist abrasion by the soil. For example, the wear member 214 may be a carbide, or tungsten plate. Preferably, the chisel tool 200 is attached to the digging shank 110 such that the chisel tool 200 works at a depth of between 200 mm to 230 mm.

Returning to FIG. 1, the plough assembly 100 further includes a seed bed forming tool 220 that is pivotally attached to an adaptor 230 that is pivotally connected to the digging shank 110, preferably in parallelogram-type attachment, such that vertical motion of the seed bed forming tool 220 as a result of vertical motion of the digging shank 110 is inhibited. Preferably the seed bed forming tool 220 is located behind the digging point 120 and works at a depth to form the seed bed at a location higher than the lowermost extremity. Preferably, the depth of the seed bed forming tool 220 is 30 mm to 70 mm. The plough assembly 100 further includes a seed delivery tube 240 attached to the seed bed forming tool 220 to deliver a seed to the bed formed by the seed bed forming tool 220.

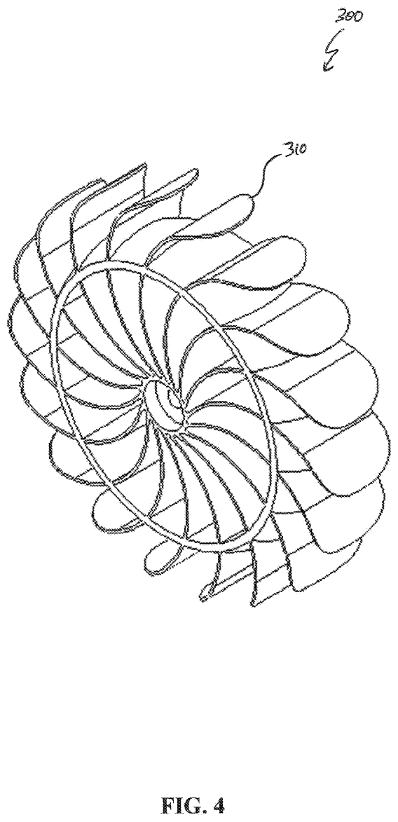

The plough assembly 100 may further include a wheel member 300 to move a portion of soil over the seed delivered by the seed deliver tube 240 and to form a furrow. The wheel member 300 is shown in more detail in FIG. 4 and includes a plurality of radially extending blades 310, each blade 310 adapted to, as the wheel member 300 traverses the soil, move a portion of soil. Preferably, the wheel member 300 has between 5 to 25 blades 310, more preferably the wheel member 300 has between 10 to 20 blades, preferably the wheel member 300 has more than 10 blades 310, most preferably the wheel member 310 has about 18 blades 310.

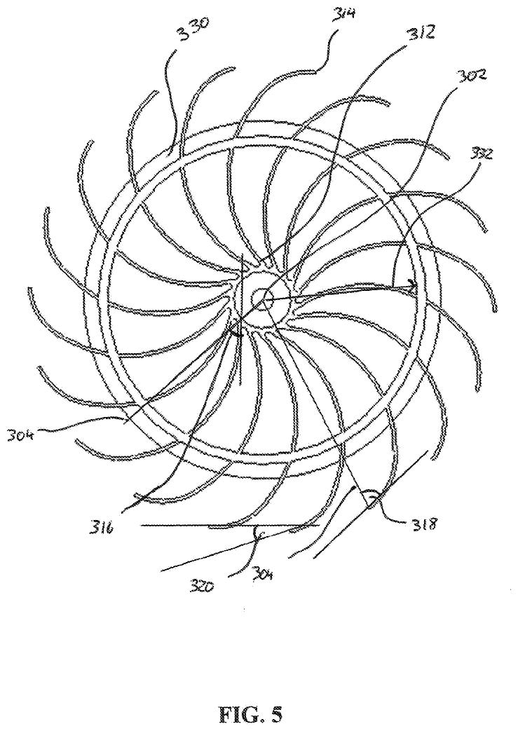

Moving to FIG. 5, the blades 310 are angled backward such that an extremity 314 of each blade 310, when the respective blade 310 is in contact with the soil layer, is oriented at a smaller angle to the soil layer than a root portion 312 of the respective blade 310 and faces away from the soil to encourage compressing of the soil rather than scooping of the soil. The root portion 312 is the portion close to a center 302 of the wheel member 300 from which the blade 310 extends radially outward. Preferably, the blade 310 is angled forward relative to a wheel radius 304 at the root portion 312 by a blade root angle 316. The angle of the blade extremity 314 to the radius 304 may be referred to as the blade tip angle 318. Preferably, the blade tip angle 318 is larger than the blade root angle 316. The blades 310 are most preferably angled such that the extremity 314 of the blade 310 is substantially parallel to the soil layer when the extremity 314 has just contacted the soil layer. This may be achieved most effectively using a sufficiently large blade root angle 316 such that, when the extremity 314 of the blade 310 is directly below the center of the wheel member 300. The angle of the blade extremity 314 at the point of contact of the blade 310 with the soil may be referred to as a blade rise angle 320. Preferably, the blade root angle 316 is between 10 to 60 degrees. Preferably, the blade tip angle 318 is between 45 to 90 degrees. Preferably, the rise angle 320 is between 5 to 40 degrees. Most preferably the blade root angle 316 is about 45 degrees, most preferably the blade tip angle is about 75 degrees, most preferably the rise angle 320 is about 15 degrees.

The blades 310 may be connected to each other by a support ring 330 that is located a radial distance 332 away from the center 302 of the wheel member 300. As only a small portion of blades 310 are engaged in working the soil at any time, the remaining blades 310 provide stiffness to resist azimuthal movement of the blades 310 working the soil between the support ring 330 and the root portion 312 at the center 302. Preferably, the support ring 330 has a D-shaped cross-section, as seen in FIG. 7, with the curved side extending radially outward to provide a rounded trough profile to the furrow being formed.

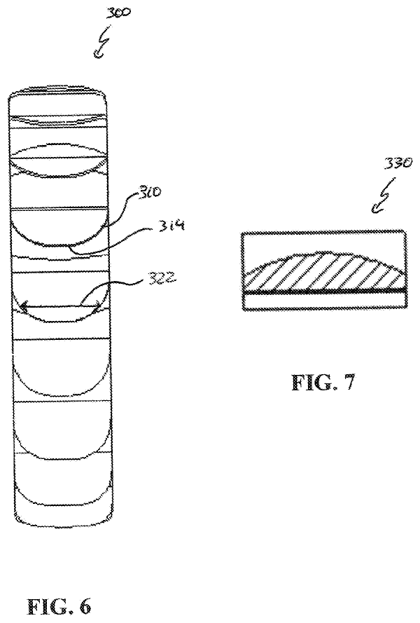

The blades 310 are preferably made from a compliant material, such as polyurethane and have a width between 50 mm to 150 mm, more preferably between 90 mm to 135 mm, as shown in FIG. 6. Most preferably, the extremity 314 of each blade is rounded or otherwise has a narrower width 322 than the majority of the blade 310.

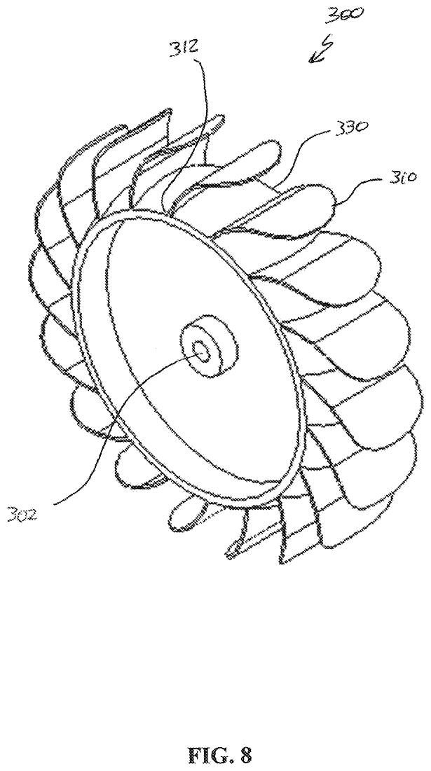

FIG. 8 shows a second embodiment of the wheel member 300, where the wheel member 300 is solid between the center 302 and the support ring 330, with the blades 310 extending radially outward from the support ring 330. The root portions 312 are located at the support ring 330 and the blade root angle is correspondingly larger to account for the further radial distance of the root portions 312 from the center 302 compared to the embodiment of FIG. 5.

The embodiment of FIG. 8 may be advantageous in that it can be manufactured from a known press wheel by adding the blades 310 as disclosed herein.

Use of the plough assembly 100 will now be discussed.

At rest, the fluid circuit 170 may be assumed to be pressurized, as the unpressurized state will only subsist until the first over-pressure event in the plough fluid line 150. When a subsequent over-pressure event occurs in the plough fluid line 150, the pressure reducing valve 160 actuates, thereby permitting fluid flow from the plough fluid line 150 to the fluid circuit 170. Simultaneously, the pilot port 174 actuates the pressure relief valve 172, thereby permitting fluid flow to the vent port 184. Due to the line restriction 192, the fluid pressure at the directional ports 176 is lower than the previous at rest pressure of the system, causing a pressure drop at the vent port 184. This actuates the vented directional valve 182 allowing fluid flow from the highly pressured fluid circuit 170 toward the check valve 190. When the over-pressure event in the plough fluid line 150 ceases, the pressure reducing valve 160 severs the connection between the fluid circuit 170 and the plough fluid line 150. Meanwhile, the pressure has equalized across the line restriction 192, causing the vented directional valve 182 to close. As the pressure drops in the plough fluid line 150, the check valve 190 opens to allow the pressurized fluid from the vented directional valve to flow into the plough fluid line 150.

As the plough assembly 100 traverses the soil surface and delivers seeds into the seed bed formed by the seed bed forming tool 220, the wheel member 300 causes a wave action of soil fines to cover the seed and forms a furrow with dish sides that taper off to the original soil surface to stop the soil edges from collapsing inwards into the furrow.

Advantages of the plough assembly 100 will now be discussed.

Because of the use of the pressure reducing valve 160 pressure and fluid levels may be managed in a fluctuating manner using the hysteresis of the fluid circuit 170. The use of the accumulator 152 protects the plough fluid line 150 against oil pressure spikes. The use of the pressure relief valve 172, the vented directional valve 182, the check valve 190, and the line restriction 192 provides a hysteresis to the fluid circuit 170 that allows management of the fluid and pressure levels of the plough assembly 100.

The use of a common plough fluid line 150 for a plurality of digging shanks 110 results in a pulsating motion of the digging shanks 110 that tolerates underground obstructions and reduces dragging of the digging points 120 as a result of disadvantageous digging angles caused by movement of the digging point 120 due to obstructions. The pulsating motion of the digging points 120 also creates a balancing force across the plurality of digging points 120 allowing the plough assembly 100 to track in line with the pulling tractor (not shown) and maintain a digging line next to the previous crop, referred to as near row sowing.

The low digging angle of the chisel tool 200 lifts large amounts of soil, reducing smearing and slotting in wet sowing conditions. The wheel member 300 creates furrows that are able to harvest rainwater and multiply inter row run off water, creating an environment for important microbes to colonize the seed bed for strong plant growth. Further, the water runoff leaves the inter row firm and dry, reducing weed growth and improving trafficability.

Integers:

| | |
|---|---|
| 10 | beam |
| 12 | longitudinal forward direction |
| 100 | Plough assembly |
| 110 | digging shank |
| 112 | lower portion |
| 120 | digging point |
| 122 | lowermost extremity |
| 124 | first direction |
| 126 | second direction |
| 130 | pivotable connector |
| 132a, b | outer plates |
| 134 | inner plate |
| 136 | bracket |
| 140 | fluid cylinder |
| 142 | first end |
| 144 | second end |
| 150 | plough fluid line |
| 152 | accumulator |
| 154 | first quick disconnect |
| 160 | pressure reducing valve |
| 170 | fluid circuit |
| 172 | pressure relief valve |
| 174 | pilot port |
| 176 | first directional port |
| 178 | second directional port |
| 180 | spring member |
| 182 | vented directional valve |
| 184 | vent port |
| 186 | first directional port |
| 188 | second directional port |
| 190 | check valve |
| 192 | line restriction |
| 194 | second quick disconnect |
| 200 | chisel tool |
| 202 | digging angle |
| 210 | chisel tool point |
| 212 | digging angle |
| 214 | wear member |
| 220 | seed bed forming tool |
| 230 | adaptor |
| 240 | seed delivery tube |
| 300 | wheel member |
| 302 | center |
| 304 | radius |
| 310 | blade |
| 312 | blade root |
| 314 | blade extremity |
| 316 | blade root angle |
| 318 | blade tip angle |
| 320 | blade rise angle |
| 322 | blade width |
| 324 | blade tip width |
| 330 | support ring |
| 332 | radial distance |

1. A plough assembly to be mounted on a beam to be moved in a longitudinal forward direction over a soil layer, having a soil surface, to be worked by the assembly, the assembly including:
a digging shank to extend downwardly into the soil layer;
a digging point having a lowermost extremity and to be fixed to a lower portion of the shank;
a pivotable connector to connect the digging shank to the beam;
a fluid cylinder mounted across the pivotable connector such that pivoting of the shank causes movement of the cylinder, the cylinder being connected to a plough fluid line;
a pressure reducing valve connecting the plough fluid line to a fluid circuit, the pressure reducing valve being adapted to release fluid pressure from the plough fluid line to the fluid circuit at a pre-determined over-pressure point.

2. The plough assembly of claim 1, wherein the plough assembly further includes an accumulator connected to the plough fluid line.

3. The plough assembly of claim 1, wherein the fluid circuit includes a pressure relief valve having a pilot port and a first and a second directional ports, the pilot being connected to the plough fluid line and the directional ports being connected in series to the fluid circuit.

4. The plough assembly of claim 3, wherein the pressure relief valve includes a spring member acting against the pilot port to provide an unload/reload pressure ratio.

5. The plough assembly of claim 3, wherein the fluid circuit includes a vented directional valve having a vent port and a first and a second directional ports, the vent port being connected to the first directional port of the pressure relief valve, the first directional port being connected to the plough fluid line, and the second directional port being connected to the fluid circuit, such that when the vent port experiences a rapid pressure drop the fluid circuit is connected to the plough fluid line.

6. The plough assembly of claim 5, wherein the plough assembly further includes a check valve between the first directional port of the vented directional valve and the plough fluid line such that fluid flow is not possible from the plough fluid line to the vented directional valve.

7. The plough assembly of claim 6, wherein the check valve is biased closed such that fluid flow from the vented directional valve to the plough fluid line is only possible when the fluid pressure at the first directional port of the vented directional valve is higher than the fluid pressure in the plough fluid line by a pre-determined value.

8. The plough assembly of claim 3, wherein the fluid circuit includes a line restriction between the fluid circuit and the second directional port of the pressure relief valve.

9. The plough assembly of claim 1, wherein the plough assembly includes a plurality of digging shanks to extend downwardly into the soil layer;
a plurality of digging points having a lowermost extremity and to be fixed to a lower portion of the respective shanks;
a plurality of pivotable connectors to connect the respective digging shanks to the beam;
a plurality of fluid cylinders mounted across the respective pivotable connectors such that pivoting of the shank causes movement of the respective cylinder, each cylinder being connected to the plough fluid line.

10. The plough assembly of claim 9, wherein pressure applied to the digging point by the soil causes pivoting of the respective shank in a first direction, resulting in compression of the respective cylinder resulting in an increase of fluid pressure in the plough fluid line such that the remainder of the plurality of fluid cylinders expands creating a moment to the remainder of the plurality of digging points in a second direction opposite the first direction.

11. The plough assembly of claim 1, wherein the digging point includes a chisel tool, the chisel tool having a digging angle of about 6 degrees relative to the longitudinal forward direction.

12. The plough assembly of claim 11, wherein the chisel tool includes a chisel tool point, the chisel tool point having a digging angle of about 30 degrees relative to the longitudinal forward direction.

13. The plough assembly of claim 12, wherein chisel tool point includes a wear member adapted to resist abrasion by the soil.

14. The plough assembly of claim 11, wherein the chisel tool is adapted to work at a depth between 200 mm to 230 mm.

15. The plough assembly of claim 1, wherein the plough assembly further includes a seed bed forming tool supported so as to be behind the digging point and to work at a depth of 30 mm to 70 mm to form the seed bed at a location higher than the lowermost extremity,
wherein the seed bed forming tool is pivotally connected to an adaptor that is pivotally connected to the digging shank, such that vertical motion of the seed bed forming tool as a result of vertical motion of the digging shank is inhibited.

16. The plough assembly of claim 15, wherein the plough assembly further includes a seed delivery tube attached to the seed bed forming tool to deliver a seed to the bed formed by the seed bed forming tool.

17. A plough assembly to be mounted on a beam to be moved in a longitudinal forward direction over a soil layer, having a soil surface, to be worked by the assembly, the assembly including:
a digging shank to extend downwardly into the soil layer;
a digging point having a lowermost extremity and to be fixed to a lower portion of the shank;
a seed bed forming tool supported so as to be behind the digging point, the seed bed forming tool forming a seed bed at a location higher than the lowermost extremity;
a seed delivery tool to deliver a seed to the bed formed by the seed bed forming tool; and
a wheel member to engage the soil behind the seed delivery tool to aid in ensuring the seed delivered to the bed is covered by soil,
wherein the wheel member includes a plurality of radially extending blades, each blade adapted to, as the wheel member traverses the soil, compress and move a portion of soil, thereby forming a furrow.

18. The plough assembly of claim 17, wherein the blades are angled backward such that an extremity of each blade, when the respective blade is in contact with the soil layer, is oriented at a smaller angle to the soil layer than a root portion of the respective blade.

19. The plough assembly of claim 18, wherein the blades are angled such that the extremity of the blade is substantially parallel to the soil layer when the extremity has contacted the soil layer and has moved behind a center of the wheel member.

20. The plough assembly of claim 17, wherein each blade has a root portion from which the blade extends radially outward, and
wherein the blade is angled forward relative to a wheel radius at the root portion.

21. The plough assembly of claim 19, wherein each blade has a root portion from which the blade extends radially outward, and
wherein the blade is angled forward relative to a wheel radius at the root portion; and
wherein the blade is angled forward relative to the wheel radius at the root portion such that, when the extremity of the blade is directly below the center of the wheel member, the extremity of the blade is angled into the soil layer to compress and move the portion of soil in a direction opposite the longitudinal forward direction.

22. The plough assembly of claim 17, wherein the blades of the wheel member are made from a compliant material, such as polyurethane.

23. The plough assembly of claim 17, wherein each blade has a width of between 50 mm to 150 mm, more preferably between 90 mm to 135 mm.

24. The plough assembly of claim 17, wherein the radially extending blades are connected to each other by a support ring located a radial distance away from a center of the wheel member to inhibit azimuthal movement of the blades between the support ring and a center of the wheel member.

25. The plough assembly of claim 24, wherein the support ring has a D-shaped cross-section, the curved side extending radially outward.

26. The plough assembly of claim 17, wherein an extremity of each blade has a narrower width than the majority of the blade.
